(19) United States
(12) Patent Application Publication
(10) Pub. No.: US 2005/0118485 A1
(43) Pub. Date: Jun. 2, 2005

(54) Bipolar plate and electrolyte application

(76) Inventors: Hazem Tawfik, Islip Terrace, NY (US); Yue Hung, Farmingdale, NY (US)

Correspondence Address: DILWORTH & BARRESE, LLP, 333 EARLE OVINGTON BLVD., UNIONDALE, NY, 11553, US

(21) Appl. No.: 10/937,242

(22) Filed: Sep. 9, 2004

Related U.S. Application Data
(63) Continuation-in-part of application No. 10/302,558, filed on Nov. 22, 2002.
(63) Continuation-in-part of application No. 10/302,559, filed on Nov. 22, 2002.

(51) Int. Cl. H01M 8/02; H01M 8/04; H01M 8/24

(52) U.S. Cl. 429/37; 429/32; 429/38; 429/39

(57) ABSTRACT

A fuel cell pack includes multiple stacked membrane-electrode assemblies each configured to have a pair of bipolar plates, which flank a membrane therebetween. Each bipolar plate has at least one of its opposite faces provided with a continuous gas-conveying channel.

### CROSS REFERENCE TO RELATED APPLICATION

This application is a continuation-in-part of U.S. Applications Ser. Nos.: 10/302,558 and 10/302,559 both filed with the U.S. Patent and Trademark Office on Nov. 22, 2002 and both fully incorporated herein by reference.

### BACKGROUND OF THE INVENTION

1. Filed of the Invention

The invention relates to a source of energy. In particular, the invention relates to a reactant flow channel formed on opposite surfaces of a bipolar plate and configured to improve chemical reaction between reactants.

2. Discussion of Related Prior Art

Due to an increasing demand on the earth's limited energy resources and to low conversion efficiencies of conventional power generation systems as well as environmental concerns, the need for a clean and reliable alternative source of energy has greatly escalated. Fuel cells have been considered for power generation applications for years. Many innovative improvements in operational performance capability have been achieved. Efficiencies have been increased; water-management problems have been resolved; and the use of proton exchange membranes with reduction of the thin film catalyst layers has been realized with the use of the High Velocity Oxygen Fuel (HVOF) thermal spray coating system to form the ion conducting layer and the electrodes layers.

Fuel cell assemblies with proton exchange membrane cells, in which a hydrogen-oxygen reaction is employed for power generation, have become a popular source of energy in an automobile industry. Unfortunately, the development of suitable stacked assemblies using the proton exchange membrane fuel cell has been subject to various problems, one of which is associated with either excessive humidity leading to flooding flow channels or excessive dryness indicating a slow-flowing chemical reaction.

The principle of operation of the bipolar fuel cell is based on a reaction between hydrogen-rich fuel breaking into ions at a membrane and electrons liberated to provide electric current and power. After providing power, the electric current joins the hydrogen ions and oxygen to produce water. The excess amount of the latter leads to flooding. Conversely, if the amount of water is insufficient, the environment is too dry indicating that the reaction between the reactants is slow. In either case, the fuel cell functions inefficiently characterized by the low cell's power output.

In a typical structure of a fuel cell stack, as reactants are guided along respective separate inlet and outlet channels, as disclosed in U.S. patent Ser. No. 6,551,736, the environment defined between these plates constantly changes. A particularly important characteristic of this environment is humidity. Not only structuring the surfaces of the bipolar plate with numerous channels may be cost-inefficient, but also the multiple-channel arrangement, particularly circularly-patterned channels, may contribute to unsatisfactory humidity distribution within the fuel cell.

It is, therefore, desirable to optimize the design of flow channels in bipolar plates of a fuel cell so that while a chemical reaction between reactants flows, no humidity is lost to the ambient with the exiting air-oxidant/oxygen from the fuel cell.

### SUMMARY OF THE INVENTION

A bipolar plate with at least one corrosion-resistant metallic or ceramic coating layer over metallic, ceramic or composites plates structured to have a reactant guiding design and assembly, which is configured with a single, continuous flow channel, attains this objective. Structurally, the inventive concept is realized by providing the single flow channel constituted by a plurality of interdigitating inlet and outlet sub-channels. Thus, the reactant flow pattern is configured so that the humidity diffusion is maximized between the exiting gas flow characterized by high humidity concentration and entering gas flow with relatively low humidity gases entering the flow field. As a consequence, humidity is preserved within the cell.

In accordance with one structural modification of the inventive concept, the single flow channel has a squire-wave pattern of inlet sub-channels and a square or triangular wave pattern of outlet sub-channels folded together so that each of the inlet sub-channels extends parallel to at least one adjacent outlet sub-channel. A further structural modification of the inventive concept includes multiple inlet and outlet sub-channels alternating with one another to form a rectangular or spiral single continuous channel extending between a reactant inlet and outlet so that the inlet and outlet sub-channel alternate with one another and exchange humidity through diffusion. This diffusion mechanism, supported by the invented design, conserves considerable amount of humidity within the cell.

It is, therefore, a principle object of the invention to provide an improved design of flow channels formed in a bipolar plate and traversed by reactants.

### BRIEF DESCRIPTION OF THE DRAWINGS

The above and other objects, features and advantages will become more readily apparent from the detailed description accompanied by the following drawings, in which:

FIG. 1 is an isometric view of the inventive fuel cell;

FIG. 2 is an exploded view of the fuel cell stack shown in FIG. 1;

FIG. 3 is a cross-sectional view of the inventive bipolar plate;

FIG. 4 is an outside isometric view of the base plate configured in accordance with the invention;

FIG. 5 is an inside isometric view of the base plates of FIG. 4;

FIG. 6 is a cross-sectional view of the inventive fuel cell stack of FIG. 1;

FIG. 7 is an isometric view of an individual bipolar plate;

FIG. 8 is a schematic view of fuel conveying channels formed on one side of the bipolar plate of FIG. 7;

FIG. 9 is a schematic view of oxygen conveying channels on the opposite side of the bipolar plate of FIG. 7;

FIG. 10 is a diagrammatic representation of the principle of operation of the inventive membrane;

FIGS. 11A and 11B are schematic and isometric views, respectively, of a continuous conveying flow channel configured in accordance with one embodiment of the invention;

FIG. 12 is a schematic view of the modified gas conveying channel shown in FIGS. 12A and 12B;

FIGS. 13A and 13B are schematic and isometric views, respectively, of a continuous conveying flow channel configured in accordance with another embodiment of the invention;

FIG. 14 is a cross-sectional view of the of the conveying channel taken along lines X-X of FIG. 9;

FIG. 15 is a sectional view of the bipolar plate of FIG. 7 taken along lines XI-XI;

FIGS. 16A-16B are top and perspective views of the bipolar plate formed with full or partial projections obstructing flow of a respective reactant gas; and

FIG. 17 is a schematic view of fuel conveying channels showing flow pattern designs developed to avoid water condensation and flooding of the membrane-electrode-assemblies (MEA) of the present invention.

### DETAILED DESCRIPTION

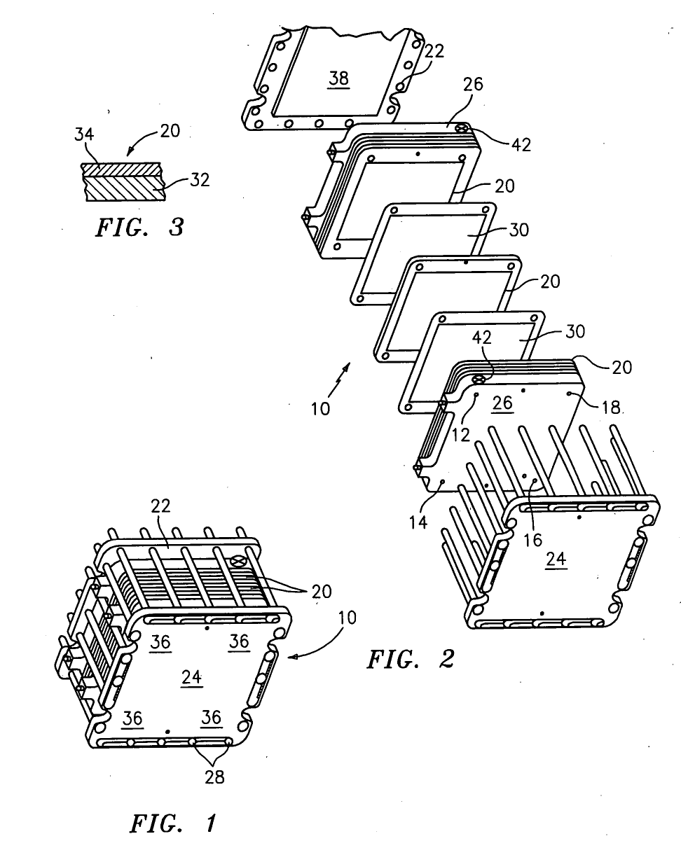

An inventive fuel cell stack 10, as shown in FIGS. 1 and 2, is configured to minimize and eliminate leakage of the reactant gases (H₂ and 0₂/air) between juxtaposed bipolar plates 20 and between end bipolar plates 26 and a respective one of base plates 22, 24. Primary external leakage-hazard regions of the fuel cell stack 10 are associated with inner manifolds 12, 14, 16, and 18 traversed by reactant gases or reactants. In particular, a first pair of spaced inner manifolds 12, 14 are traversed by incoming and outgoing fuel, such as hydrogen, whereas another pair of inner manifolds are traversed by oxidant (0₂/air) entering an inlet manifold 16 and exiting, as water, through an outlet manifold 18. A further leakage-prone region of the fuel cell stack 10 includes an interface between base plates 22, 24 and end bipolar plates 26 each of which is adjacent to a respective one of the base plates. Accordingly, the inventive structure of the fuel cell stack 10 is configured to at least minimize, if not to completely eliminate, the possibility of external and/or internal gaseous leaks in the above-identified regions.

The fuel cell stack 10 includes a plurality of consecutive membrane-electrode-assemblies (MEA) each of which is assembled from a membrane 30 sandwiched by two electrodes (not shown) and by two bipolar plates 20. Base plates 22 and 24 tend to compress the membrane-electrode assemblies upon applying a torque to the tie rods 28.

Each individual bipolar plate 20 (FIG. 3) has a structure including a metal substrate 32, which is made preferably from aluminum or another low-resistance metal, and a metallic corrosion resistant layer 34. Other low resistant metals suitable for the substrate 32 may further include, but are not limited to aluminum, stainless steel, inconnel, aluminum alloys, zinc, zinc alloys, magnesium, magnesium alloys. The corrosion resistant layer 34 is provided within a boundary region of the substrate upon impinging a plurality of metallic powdered particles onto a boundary region of the metal substrate at high velocities. As a result, the impinged metallic powdered particles splat across and embed in the boundary region of the metal substrate to metallurgically interlock therewith. It was found particularly advantageous to prepare the corrosion resistant layer 34 from nickel-, chromium- and carbon-based metallic powders deposited by a thermo-spray technique, including, but not limited to the high velocity oxygen fuel technology and detonation. However, even though metal-based bipolar plates 20 are particularly favored, the scope of the present invention does not exclude the use of graphite-based bipolar plates that can be particularly useful in highly acidic environment.

One of the structural advantages of using the metal bipolar plates 20, 26 stems from its excellent load-bearing characteristics. To reliably compress the bipolar plates together and, thus, to minimize and eliminate the external gas leakage between regions of juxtaposed bipolar plates 20 formed with inner manifolds 12-18 (FIG. 2), a torque should be applied to the tie rods 28. The higher the torque, the higher the pressure on the bipolar plates 20 and the gaskets located between the bipolar plates. However, these forces tend to deform the base plates 22, 24 so that each of the plates has an outwardly curved cross-section. As a result, the deformed base plates 22, 24 cause non-uniform distribution of compressing forces imposed on the end bipolar plates 26. A particularly troubling consequence of the base plates' repeated deformation is an inadequate compression between juxtaposed bipolar plates as well as membranes and gaskets in the vicinity of the manifolds 12-18 leading to the external leakage of reactant gases.

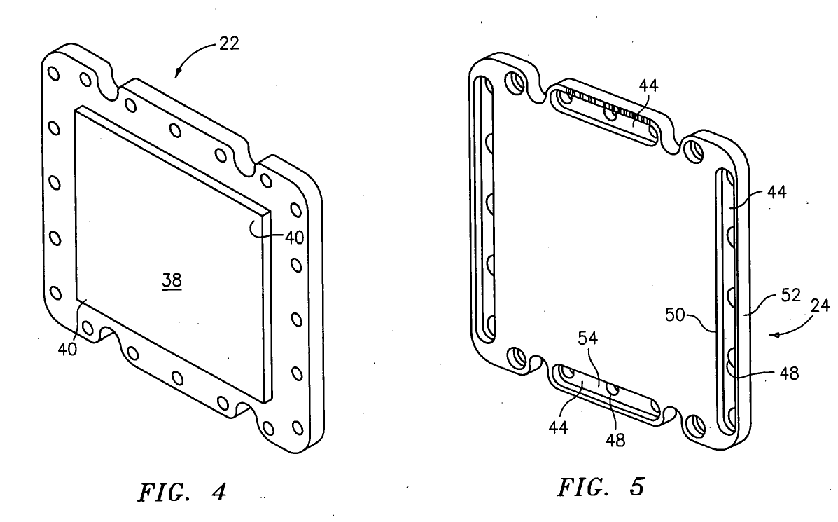

In accordance with one aspect of the invention, to minimize the external leakages, the base plates 22, 24 each have a raised central region 38 that can be cascaded in a stepwise fashion, as better seen in FIGS. 2 and 4. To convert the torque applied to the tie rods 28 into compressing forces, which cause the inner regions 36 (FIG. 1) of the base plates 22, 24 to press against the regions with manifolds 12-18 of the bipolar plates 20, 26, corners 40 (FIG. 4) of the raised central region 38 each are aligned with a respective one of four manifolds 12-18. Thus, although the compression forces still tend to bend the base plates 22, 24, a stepwise structure of the latter resists this deformation and improves the transmission of compression forces from the base plates 22, 24 to the end bipolar plates 26 and further to the inner bipolar plates 20. Hence, the components of stacked MEAs reliably urge against one another minimizing the risk of the external and/or internal gas leakage. While numerous shapes of the raised central region 38 (FIG. 4) pf the base plates 22, 24 are envisioned within the scope of the invention, invariably this region should be configured to have its corner regions 40 aligned with the manifolds 12-18.

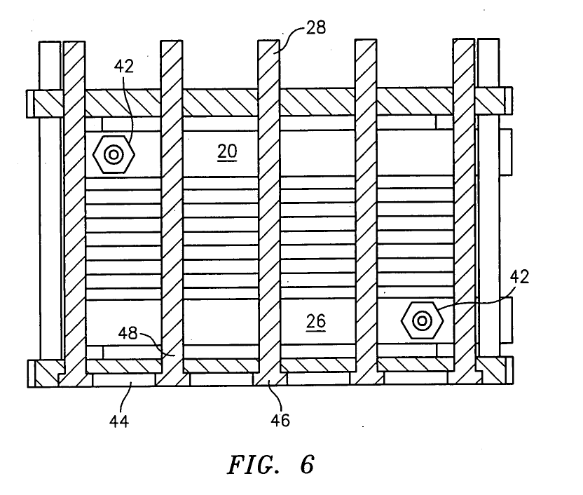

According to another aspect of the invention, the fuel cell stack 10, as shown in FIGS. 2 and 6, includes multiple fittings 42 (only two are shown in FIG. 2). Each of these fittings is configured to provide flow communication between the reactant tank gas tanks (not shown) and the inner manifolds 12-18 of the fuel cell stack 10. Conventionally, the fittings 42 are located on the base plates 22, 24; such a structure requires formation of additional manifolds in the plates guiding gases through the manifolds 12-18 formed in the bipolar plates. In contrast, the invention provides for the fittings 42 to be directly mounted to the end bipolar plates 26. Hence, additional and potentially leak-hazard regions between the base plates 22, 24 and the end bipolar plates 26 are eliminated. Note that if not for the metal end bipolar plates 26, such a structure would not be feasible, since the graphite-based plates would not have sufficient rigidity to support the mounted fittings.

Referring to FIGS. 5 and 6, to facilitate the assembly of the fuel cell stack 10 having a plurality of stacked MEAs, one of the base plates 22, 24 (FIG. 5) has a plurality of peripheral channels 44 configured so that the width and depth of these channels 44 are sufficient to receive polygonal heads 46 (FIG. 6) of the tie rods 28. Advantageously, the channels 44 are configured to fully receive the polygonal heads 46, which, thus, do not project beyond the outer surface of the base plate 24, whereas the opposite sides 50, 52 (FIG. 5) of each channel 44, defining its width, flank the polygonal heads 46 to prevent them from rotating in response to a torque applied to the opposite ends of the tie rods 28. To reliably guide the tie rods 28 between the base plates 24, 22, bottoms 54 of the channels 44 are machined with a plurality of holes 48 dimensioned to allow the tie rods 28 to slide therethrough. As a consequence, during assembly of the fuel cell stack 10, the tie rods 28 are easily and reliably inserted through the base plates 22, 24. It is preferred to use corrosion resistant materials, such as stainless steel, for the inlet and outlet fittings 42 as well as for other fasteners securing the fuel cell pack tight.

Note that instead of four channels 44, as shown in the drawings, it is conceived to have either a single peripheral channel. Alternatively, a multiplicity of channels each dimensioned to correspond to the dimension of the individual polygonal head 46 is still another modification conceived within the scope of the invention.

In order to increase power density of the fuel cell stack 10, the polarities of adjacent fuel cells are combined together. The positive polarity of one cell combined with the negative polarity of the adjacent one form the bipolar plate 20. The bipolar plate carries hydrogen, which is necessary for the negative polarity of the bipolar plate, and oxygen/air for its positive polarity. As known, water is a byproduct generated in the oxygen side of the bipolar plate 20. Improper water management will decrease the power output of the fuel cell, or it could eventually stop the electrochemical operation of the fuel cell because of possible water flooding or drying out of the membrane that could cause small holes and/or cracks in the membrane.

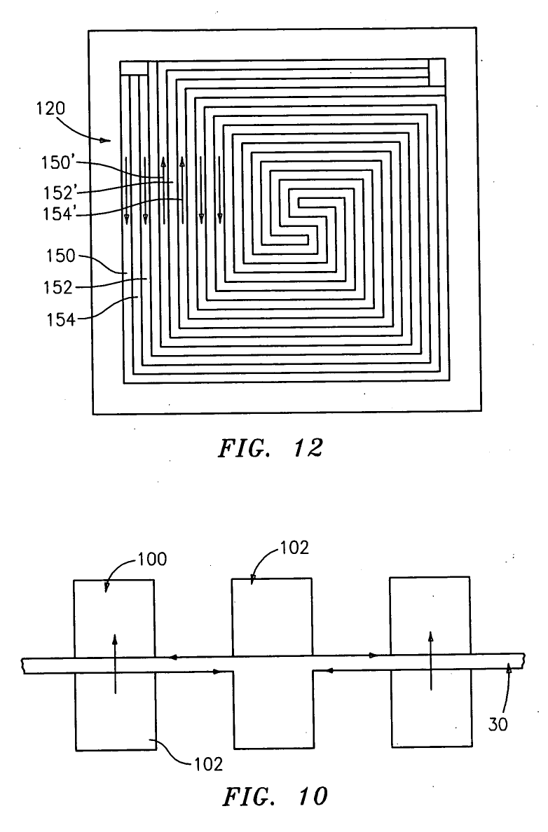

FIGS. 8 and 9 show one of possible designs of gas conveying channels formed in the bipolar plate for the hydrogen side and for the oxygen side, respectively. As shown in FIG. 8, inlet channels 58 are in flow communication with the manifold 12 (FIG. 2) and in flow communication with return channels 60 via a connecting channel 62. The channels are designed in horizontal zigzag configuration to prolong its dwelling in the conduits 12, 14 and give more opportunity for reaction with oxygen to take place. The serpentine area on the oxygen side (FIG. 9) is designed by pointing channels 64 communicating with the inlet manifold 16 downward such that water is drained by gravity, as indicated by an arrow 66, through the outlet manifold 18.

As mentioned before, one of the byproducts of the reaction between hydrogen and oxygen is water, which is typically accumulated on the cathode (oxygen) face of the membrane-electrode assemblies. The excessive amount of water is detrimental to the efficient power output of the fuel cell. Conversely, insufficient humidity is indicative of inefficiency of the fuel cell. To provide the desirable environment and to establish the optimal humidity, the membrane 30 (FIGS. 1, 2) is selected to possess seemingly contradictory qualities: water-absorption and water-repellency.

Turning to FIG. 10 illustrating the uniqueness of the membrane 30, it can be seen that if one of adjacent gas-conveying channels 100 and 102 is relatively dry and the other is relatively humid, the membrane would serve as a media for water diffusion. Typically, the excess of water would tend to be conveyed through the membrane 30 from the relatively humid channel 102 to the relatively dry channel 100.

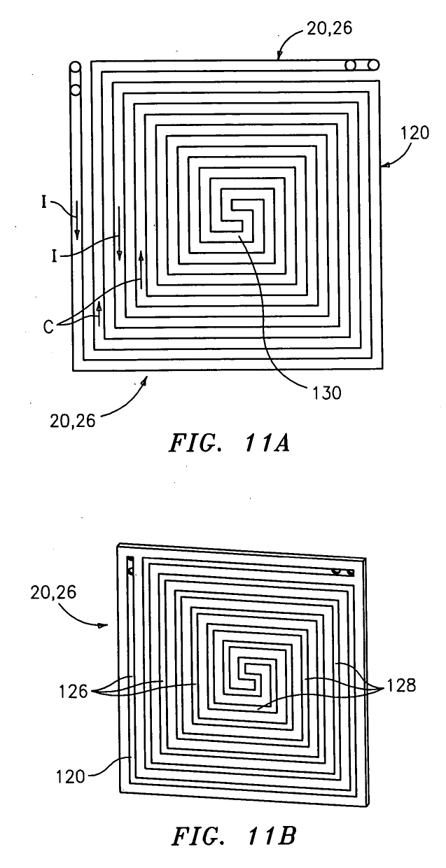

In addition to the membrane 30, the topography of gas conveying channels is as important for the efficiency of the fuel cell as the structure of the membrane. FIGS. 11A-11B illustrate a particularly advantageous configuration of the bipolar plates 20, 26 provided with a continuous gas conveying channel 120 having a plurality of inlet sub-channels 126, a plurality of outlet sub-channels 128 and a transitional region 130. The latter is the region along which the inflow of the gas reactants, as indicated by arrows I, reverses its direction to a counter-flow C. Thus, the continuous gas-conveying channel 120 includes an upstream portion defined by a plurality of inlet sub-channels, a downstream portion including the plurality of outlet sub-channels, and the intermediary portion formed in the transitional region 130. The sub-channels alternate with one another so that typically relatively dry inlet sub-channels are positioned adjacent to relatively humid outlet sub-channels. Due to the membrane 30 (FIG. 2) covering the sub-channels and close juxtaposition of the inlet and outlet sub-channels, the reactant humidity is conserved on each side of the membrane 30. As shown in FIGS. 11 and 11B, the continuous gas-conveying channel 120 is uniformly dimensioned and shaped. However, in certain situations, this channel may have differently dimensioned and shaped sub-channels.

The continuous gas-conveying channel 120 is arranged in a generally polygonal pattern characterized by straight sub-channels. Alternatively to the single inlet/single outlet arrangement of FIG. 11A-B, FIG. 12 illustrates the continuous gas-conveying channel 120 longitudinally divided so that a few adjacent inlet sub-channels 150, 152, 154 follow a few consecutive outlet sub-channels 150′, 152′ and 154′ and conversely. Thus, while the principle of the direct juxtaposition between the inlet and outlet sub-channels remains the same, a number of these sub-channels are increased.

Still another modification of the above-discussed configuration includes a spiral pattern (not shown) of the continuous gas-conveying channel. Similarly to the configurations shown in FIGS. 11A, 11B, and 12, the transitional region is positioned in the center of the pattern, which substantially coincides with the central region of the bipolar plate 20, 26.

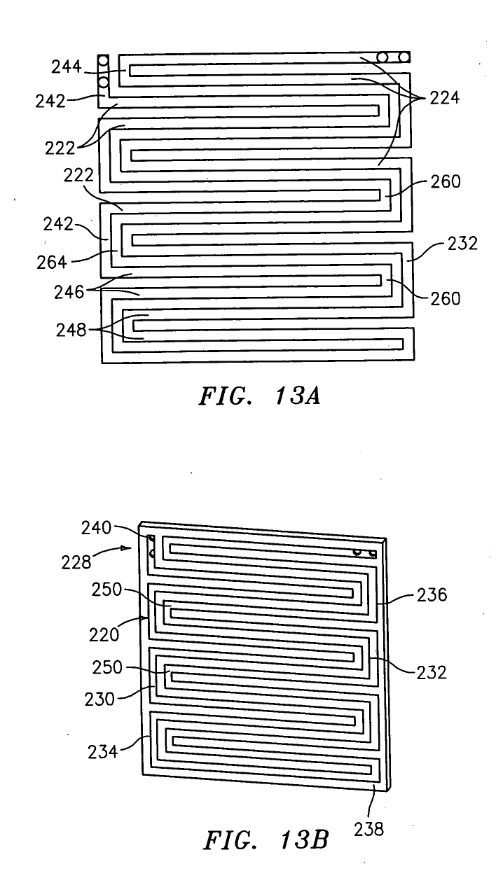

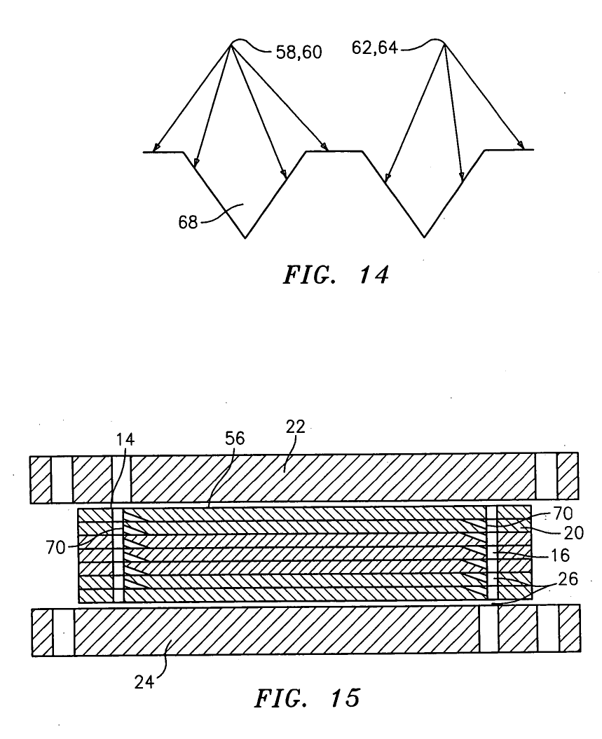

Turning to FIGS. 13A-13B, the continuous gas conveying channel 220 includes a plurality of inlet and outlet sub-channels 222, 224 each formed in a respective wave pattern, which is characterized by a plurality of subsequent troughs 230, 234 for inlet sub-channels and 232, 236 for the outlet sub-channels. Similarly to the configuration shown in FIGS. 11A and 11B, the continuous gas-conveying channel 220 has a transitional region 238 formed in a corner region of the bipolar plate, which is spaced diagonally from a corner region 228 traversed by an inlet 240. The wave pattern of each of the upstream portion of the continuous channel 220 defined by a plurality of inlet sub-channels 222 as well the downstream portion of this channel, as shown in FIGS. 13A and B, is squire-wave and, thus, is characterized by straight sub-channels. However, the wave pattern may include a sine-shaped pattern (not shown), wherein the troughs and peaks would be defined by curved regions of the sub-channels. Regardless of the type of the wave pattern, each of the troughs of the inlet sub-channel configuration of the continuous channel 220 receives a respective peak 250 of the outlet sub-channel configuration; conversely, peaks 260 of the inlet sub-channels are received within the troughs of outlet sub-channels. A short inlet sub-channels 242 each are juxtaposed with a respective short outlet sub-channel 244, whereas each pair of long inlet sub-channels 246 alternate with a pair of long outlet sub-channels 248. This configuration can be reversed by having sub-channels 242 and 244 longer than sub-channels 246 and 248.

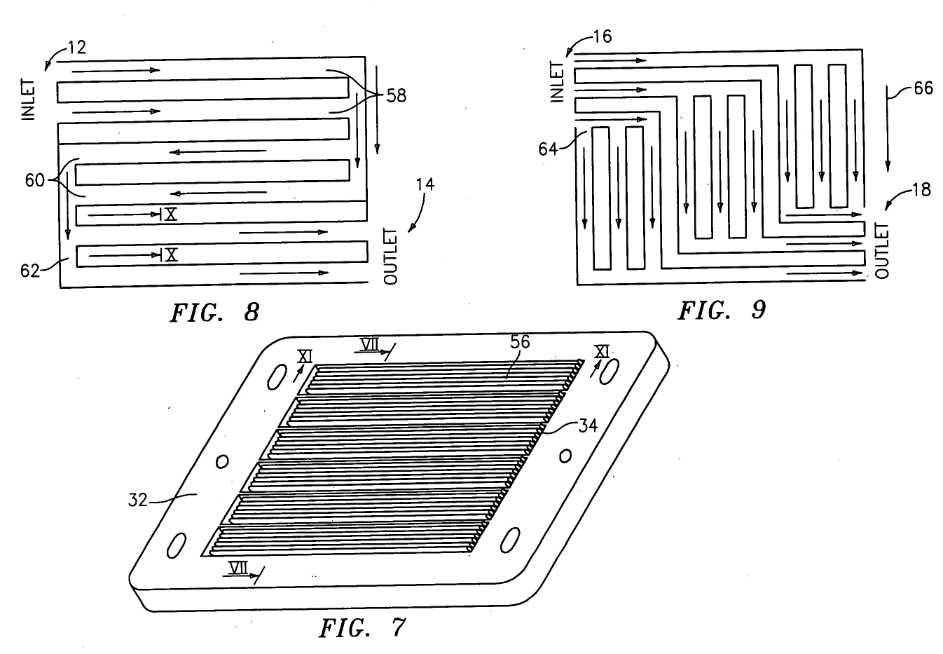

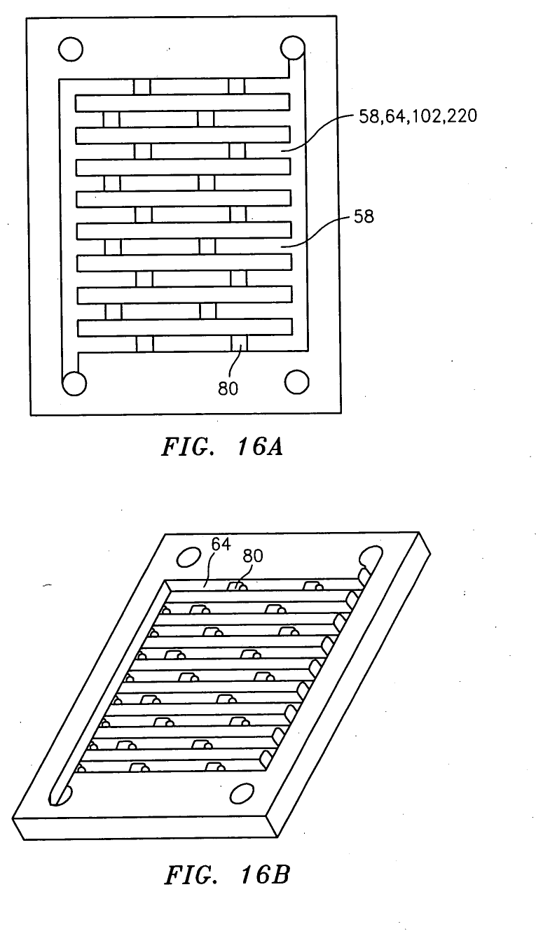

To reliably bond the metal corrosion-resistant layer 34 (FIG. 7) on the metal substrate 34, the gas-conveying channels 58, 60, 62 and 64 as well as the channels of FIGS. 11-13 each have a V-shaped or U-shaped cross-section 68, as shown in FIG. 14. A further improvement directed to minimizing the risk of gas leaks is illustrated in FIG. 15 and includes a plurality of slanted channels 70 providing flow communication between the manifolds 12-14 (16-18) and the gas conveying serpentine 56 provided in each bipolar plate 20, 26.

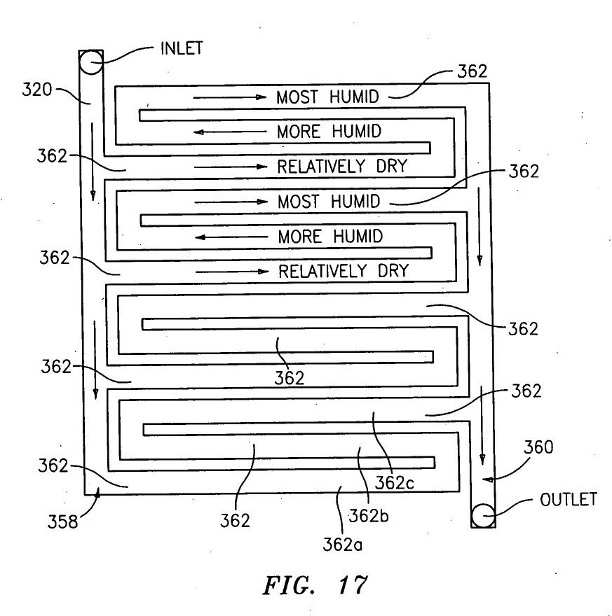

To further enhance the reaction between the gas reactants, the gas conveying channels or conduits 58, 64, 102, and 220 have projections 80, as illustrated in FIGS. 16A and 16B. Flow obstruction provided by the projections 80 redirect gas flow towards the membrane 30 (FIG. 2) and, thus, enhances the reaction of the reactant gases with the ambient air or electrolyte. A number and particular shape of the projections 80, which can be configured to fully or partially block the flow, are subject to given conditions. As a result of the projections 80, the power density output of the fuel cell pack is greatly improved due to the enhanced interaction between the reactant gases and reactant electrode assemblies.

FIG. 17 shows another of possible designs of the present invention of gas conveying channels formed in the bipolar plate for the hydrogen side and for the oxygen side. As shown, inlet channels 358 is in flow communication with the manifold 312 and in flow communication with the return channels 360 via connecting channels 362. Connecting channels 362 comprise at least two folds creating three connecting sub-channels 362a, 362b, and 362c. Unlike the configurations shown in FIGS. 11A, 11B, and 12, transitional regions are not positioned in the center of the pattern, but evenly spread out. Furthermore, similar to the configuration shown in FIGS. 11A, 11B, and 12 and unlike that shown in FIGS. 8 and 9, this design comprises only one manifold 312 and the gas conveying channel 320.

The inventive flow pattern design shown in FIG. 17, was developed to conserve humidity and minimize reactant pressure drop through the flow channel to avoid water condensation and flooding of the MEA. This flow pattern design is shifted off center, such that the inlet channel 358 is physically supported and backing an MEA membrane 30 (FIG. 2) and electrodes by the next bipolar plate 20, 26 (FIGS. 2 and 6) to minimize pin holes, cracking, and tearing of the polymer membrane 30 caused by pressure difference across the membrane combined with internal tensile and compression stresses in the membrane resulting from non-uniform shrinking and swelling of the membrane due to uneven humidity distribution on the MEA.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

1. A bipolar plate comprising opposite faces juxtaposed with one another and at least one of the opposite faces having a continuous reactant conveying channel provided with alternated inlet and outlet sub-channels.

2. The bipolar plate of claim 1, further comprising spaced apart inlet and outlet configured to deliver and evacuate a gaseous reactant, respectively, and each opening into the opposite faces, the inlet and outlet sub-channels defining an upstream and downstream portion of the continuous gas conveying channel, respectively, and being in flow communication with the inlet and outlet to provide a flow of the gaseous reactant along the upstream portion of and a counter-flow of the gaseous reactant along the downstream portion of the continuous reactant conveying channel.

3. The bipolar plate of claim 2, wherein the continuous reactant conveying channel is configured to have a pair of elongated walls extending inwards from a surface of the at least one face of the reactant continuous conveying channel and flanking a bottom of the continuous reactant conveying channel.

4. The bipolar plate of claim 3, wherein the continuous reactant conveying channel is arranged in a polygonal pattern having a plurality of spaced apart corners, wherein each of the plurality of inlet sub-channels extends linearly and parallel to a respective one of the plurality of the outlet sub-channels.

5. The bipolar plate of claim 4, wherein the continuous reactant conveying channel has a transitional region spaced equidistantly from the plurality of spaced apart corners and between the plurality of inlet and outlet sub-channels to provide flow communication therebetween.

6. The bipolar plate of claim 3, wherein the continuous reactant conveying channel is arranged in a spiral or polygonal pattern, wherein each of the plurality of inlet sub-channels extends parallel to a respective one of the plurality of the outlet sub-channels, the continuous reactant conveying channel having a transitional region located in a center of the spiral or polygonal pattern and between the plurality of inlet and outlet sub-channels to provide flow communication therebetween.

7. The bipolar plate of claim 1, wherein the continuous reactant conveying channel is uniformly shaped and dimensioned.

8. The bipolar plate of claim 3, wherein the plurality of inlet and outlet sub-channels of the continuous reactant conveying channel each are formed in a respective wave pattern having a plurality of subsequent troughs and peaks, wherein each of the troughs of one of the wave patterns receives a respective peak of the other wave pattern so that each of the plurality of inlet sub-channels is juxtaposed with a respective one of the plurality of outlet sub-channels, the wave patterns of the plurality of inlet and outlet sub-channels cumulatively forming spaced apart corner regions on the at least one face of the bipolar plate, wherein one of the spaced apart corner regions is provided with the inlet.

9. The bipolar plate of claim 8, wherein the wave patterns of the plurality of inlet sub-channels and outlet sub-channels are identical and selected from a square wave pattern or a sinusoid wave pattern.

10. The bipolar plate of claim 2, wherein the continuous reactant conveying channel further has a transitional region located in a corner region spaced diagonally from the one corner region formed with the inlet to provide flow communication between the inlet and outlet sub-channels.

11. A bipolar plate comprising:
a body provided with opposite faces and made from a metal substrate and covered by a metallic corrosion-resistant layer, which is provided within a boundary region of the substrate upon impinging a plurality of metallic powdered particles onto a boundary region of the metal substrate at high velocities so that the impinged metallic powdered particles splat across and embed in the boundary region of the metal substrate to metallurgically interlock therewith; and
a continuous reactant conveying channel formed in at least one of the opposite faces of the body including a plurality of alternating inlet and out let sub-channels traversed by oppositely directed flows of reactant.

12. The bipolar plate of claim 11, wherein the powdered metallic particles are selected from the group consisting of nickel-based alloys, chromium-based alloy and carbide-based alloy and a combination thereof.

13. The bipolar plate of claim 1 1, wherein the metal substrate is selected from the group consisting of aluminum, stainless steel, aluminum, aluminum alloys, zinc, zinc alloys, magnesium, magnesium alloys and a combination of these.

14. A fuel cell pack comprising a plurality of stacked membrane-electrode assemblies and two base plates sandwiching the membrane-electrode assemblies and each being provided with a respective raised inner central region configured so that when compressing forces are applied to the base plates, each of the raised central regions presses uniformly against an adjacent membrane-electrode assembly to compress the stacked membrane-electrode assemblies, each of the membrane-electrode assemblies being provided with a membrane sandwiched between two bipolar plates, each bipolar plate having a pair of opposite faces juxtaposed with one another, at least one of the opposite faces being provided with a continuous reactant conveying channel.

15. The fuel cell pack of claim 14, wherein each bipolar plate is made from metal, graphite or graphite composite and has spaced apart inlet and outlet configured to deliver and evacuate reactant gases, respectively, the continuous reactant conveying channel extending between and being in flow communication with the inlet and outlet.

16. The fuel cell pack of claim 15, wherein each of the bipolar plates has first and second inlet inner manifolds traversed by reactant gases and in flow communication with the opposite faces of the bipolar plate and third and fourth outlet inner manifolds spaced from and in flow communication with the first and second inner inlet manifolds for evacuating byproducts of the reaction of the reactant gases in the membrane guided along the continuous reactant conveying channel.

17. The fuel cell pack of claim 16, wherein the raised central region has a peripheral region aligned with the inner manifolds to uniformly distribute compressing forces across the bipolar plates.

18. The fuel cell pack of claim 17, wherein the raised central region and the bipolar plates are dimensioned substantially uniformly.

19. The fuel cell pack of claim 15, wherein the bipolar plates each have a metallic substrate and a metallic corrosion resistant layer bonded to the metallic substrate to minimize oxidation of the bipolar plates.

20. The fuel cell pack of claim 16, wherein the reactant conveying channel is provided with an upstream region in flow communication with the first and third inner manifolds, respectively, and a downstream region in flow communication with the second and forth inner manifolds.

21. The fuel cell pack of claim 20, wherein the continuous reactant conveying channel has a V cross-section.

22. The fuel cell pack of claim 20, wherein the upstream and downstream regions of the continuous reactant conveying channel have a respective slanted region extending from the inner manifolds at an angle differing from a right angle.

23. The fuel cell pack of claim 16, further comprising a plurality of fittings guiding the reactant gases to the inner first and third inlet manifolds and evacuating the byproducts of the reaction of the reactant gases from the inner second and fourth outlet manifolds traversing the plurality of the bipolar plates.

24. The fuel cell pack of claim 23, wherein one pair of the plurality of fittings are directly mounted to one of the two end bipolar plates and another pair of fitting are mounted to the other end bipolar plate, wherein the fitting of the one pair are inlet port fittings each in flow communication with a respective outlet port fitting of the other pair of fittings and spaced diagonally therefrom across the fuel cell pack.

25. The fuel cell pack of claim 14, wherein the at least one face of the bipolar plate has at least one elongated peripheral channel, which has a bottom terminating at a distance from an opposite face of the at least one base plate and a plurality of holes opening into the opposite face of the one base plate.

26. The fuel cell pack of claim 25, further comprising a plurality of tie rods extending through the base plates of the and each having a polygonal head dimensioned to fit the channel and a stem extending through a respective pair of holes of the one and other base plates.

27. The fuel cell pack of claim 26, wherein the channel is shaped to prevent rotation of the polygonal heads upon applying a torque to opposite end of the tie rods, which extend beyond the opposite face of the other base plate, and is sized to receive the polygonal heads so that the polygonal heads lie flush with the opposite face of the one base plate.

28. A bipolar plate comprising opposite faces juxtaposed with one another and at least one of the opposite faces having a continuous reactant conveying channel arranged in a polygonal pattern having a plurality of spaced apart corners, the continuous reactant conveying channel being provided with inlet and outlet channels configured to deliver and evacuate a gaseous reactant, respectively,
wherein the inlet and outlet channels being connected by a plurality of connecting-channels each having at least two folds creating three connecting sub-channels, the connecting sub-channels being in flow communication with the inlet and outlet channels to provide a flow of the gaseous reactant.

29. The bipolar plate of claim 28, wherein a reactant of a first humidity passes from the inlet channel through a first connecting sub-channel, a reactant of a second humidity passes through the second connecting sub-channel to a third connecting sub-channel, and a reactant of a third humidity passes through the third connecting sub-channel to the outlet channel.

30. The bipolar plate of claim 28, wherein the first humidity is dry, the second humidity is more humid than the first humidity and the third humidity is more humid than the second humidity.
